(19) United States
(12) Patent Application Publication
(10) Pub. No.: US 2012/0266403 A1
(43) Pub. Date: Oct. 25, 2012

(54) Arrangement of a Wiper System Having an Associated Windshield Washer System on a Motor Vehicle

(75) Inventors: Holger Fitterer, Rheinstetten (DE); Heiko Schmid, Oberriexingen (DE)

(73) Assignee: Daimier AG, Stuttgart (DE)

(21) Appl. No.: 13/516,971

(22) PCT Filed: Dec. 3, 2010
(86) PCT No.: PCT/EP2010/007367

§ 371 Date: Jul. 9, 2012

(30) Foreign Application Priority Data
Dec. 19, 2009 (EP) 10 2009 059 154.0

(51) Int. Cl. B60S 1/04; B60S 1/52

(52) U.S. Cl. 15/250.04

(57) ABSTRACT

An arrangement of a windscreen wiper system with an associated windscreen washer system on a motor vehicle is provided. The windscreen washer system includes a washer fluid supply line to which are connected, downstream of a branch point, at least two distribution lines leading to respective outlets. The outlets can be moved together with a corresponding wiper arm of the windscreen wiper system. A distributing device can control an emergence of washer fluid from at least one of the outlets. The distributing device can be located in an engine compartment or stowage space of the motor vehicle.

### BACKGROUND AND SUMMARY OF THE INVENTION

Exemplary embodiments of the invention are directed to an arrangement of a windscreen wiper system with an associated windscreen washer system on a motor vehicle. The windscreen washer system comprises a washer fluid supply line that is connected, downstream of a branch point, to at least two distribution lines leading to respective outlets. The outlets can be moved together with a corresponding wiper arm of the windscreen wiper system. A distributing device provides control of an emergence of wiper fluid from at least one of the outlets.

German Patent Document DE 36 43 476 A1 describes a reciprocating stroke wiper system of a motor vehicle, wherein nozzles for washer fluid that are arranged on a wiper arm are moved together with the wiper arm. A drive shaft of the wiper arm is provided with an axial bore that is divided into two independent delivery passages for the washer fluid by an axial separating web. By means of a gate provided in a connecting piece for connecting a flexible conduit, the washer fluid can be fed to either of the delivery passages. The delivery passages then lead to the nozzles. The gate is rotated with the pivoting movement of the drive shaft, which effects a reciprocating movement of the wiper arm. This ensures that the washer fluid is delivered to the nozzles, which are positioned in front of the wiper arm as viewed in the wiping direction.

A windscreen washer system of this type has the disadvantage that the distribution of the washer fluid between the delivery passages is technically complex and subject to faults.

Exemplary embodiments of the present invention are directed an arrangement of the type referred to above that simplifies the distribution of the washer fluid between the outlets.

In the arrangement of a windscreen wiper system with an associated windscreen washer system on a motor vehicle according to the invention, the windscreen washer system comprises a washer fluid supply line that is adjoined, downstream of a branch point, by at least two distribution lines leading to respective outlets. The outlets can be moved together with a corresponding wiper arm of the windscreen wiper system. A distributing device provides for control of an emergence of wiper fluid from at least one of the outlets, the distributing device being located in an engine compartment or stowage space of the motor vehicle. This stowage space may be a motor vehicle trunk. The windscreen washer system may further be assigned to a wiper system in the rear of the motor vehicle.

In the engine compartment or stowage space of the motor vehicle, it is comparatively easy to provide enough space for the accommodation of the distributing device. In addition, the distributing device is protected particularly well against external influences, in particular against the weather. The washer fluid can further be heated in the region of the distributing device by technically extremely simple means. If the distributing device is defective, it can be replaced. The distributing device can be joined to a bearing of the wiper arm, for example of a driver-side wiper arm.

The distributing device ensures that the washer fluid emerges from the desired outlet. As the outlets are moved together with the wiper arm, the washer fluid emerges in the immediate vicinity of the desired point of application.

This is accompanied by a better cleaning action of the windscreen wiper system. Furthermore, the consumption of washer fluid can be reduced, allowing a particularly small reservoir for washer fluid to be used. When arranging the windscreen wiper system in the motor vehicle, this results in a reduction of the weight of the motor vehicle and thus in a reduction of emissions, in particular of the carbon dioxide emissions, of the motor vehicle.

If comparatively little washer fluid is sprayed on a windscreen of the motor vehicle in a well-aimed and precisely timed manner, a wiper blade of the windscreen wiper system draws back a particularly small amount of washer fluid when the wiper arm has reached its reversing position and the wiping direction changes. Hardly any washer fluid is therefore drawn back into a region of the windscreen where this is undesirable. The effect on the field of view of the driver of the motor vehicle is therefore minimized.

The spread of inaccurately aimed and/or undesirably large amounts of washer fluid to windows close to the windscreen to be wiped, such as side windows and/or a roof of the motor vehicle, can therefore be largely avoided as well. The application of comparably little washer fluid to the windscreen to be cleaned further has the result that comparatively little washer fluid that would then drip onto undesirable points of the windscreen can be carried along by the wiper arm and/or the wiper blade and/or by a coupling part coupling the wiper arm and the wiper blade.

In an advantageous further development of the invention, at least one shut-off device for blocking at least one of the distribution lines is provided within a common housing of the distributing device. The provision of one shut-off device in each distribution line in the common housing facilitates the control of the shut-off devices. In a maintenance and/or repair operation, the shut-off devices are accessible particularly easily. The washer fluid can further be heated in the region of the shut-off devices by technically extremely simple means if the shut-off devices are accommodated within the housing of the distributing device. The freezing of the shut-off devices can therefore be prevented even at temperatures below freezing point, so that their functional efficiency is ensured.

It is further advantageous if at least two shut-off devices can be controlled independently. All shut-off devices are preferably independently controllable, so that the outlets through which the washer fluid is to be applied to the windscreen can be enabled accurately as desired. Preferably, outlets moving with a driver-side wiper arm and outlets moving with a passenger-side wiper arm can be enabled independently of each other.

Particularly short switching times can be achieved if the shut-off device is designed as a solenoid-operated switching element. The shut-off device further advantageously comprises a check valve, so that an undesirable return flow of washer fluid through the respective distribution line is prevented.

It is further advantageous if a first outlet is at least substantially oriented in one wiping direction and a second outlet is oriented in an opposite wiping direction. This makes it possible to apply washer fluid to the windscreen in the wiping direction via the first outlet. As the wiping direction of the wiper arm changes, washer fluid can then be admitted to the second outlet.

In the case of a comparably dirty windscreen, in particular, it may be useful to use both outlets simultaneously at least temporarily. It is also conceivable that the emergence of washer fluid from the first outlet oriented in the wiping direction could be blocked shortly before the wiper arm reaches its reversing position while allowing the emergence of wiper fluid from the second outlet by opening the shut-off device. This results in a particularly effective cleaning of the very dirty windscreen. An early application of washer fluid to the windscreen can soften stubborn dirt and therefore offer a better wiping result.

It has further been shown to be advantageous if the first outlet and/or the second outlet is/are positioned on the wiper blade of the windscreen wiper system. For it the washer fluid hits the windscreen in the region of the wiper blade, it can be applied particularly precisely and economically.

A particularly good wiping result together with a particularly economical and efficient use of washer fluid can be obtained if the outlets are designed as nozzles distributed over a length range. If the outlets are arranged on the wiper blade, the length range preferably extends along the longitudinal dimension of the wiper blade.

It has further been shown to be advantageous if the distributing device has at least one connection—which can also be referred to as a port—through which an additive can be introduced into the washer fluid. Such an additive may be a cleaning solution—e.g. an insect removing agent—and/or a heated medium, in particular a heated washer fluid. Depending on the additive to be introduced, a separate connection may be provided.

If the windscreen wiper system comprises two or more wiper arms, the at least two distribution lines are advantageously assigned to one each of the wiper arms. In this case, a shut-off device is preferably provided for each distribution line. In this way, washer fluid can be admitted to an outlet oriented in the wiping direction on a driver-side wiper arm or wiper blade and on a passenger-side wiper arm or wiper blade by opening the respective shut-off device. In the same way, washer fluid can be admitted to the windscreen against the wiping direction for the driver-side wiper blade and/or for the passenger-side wiper blade.

It has finally been found to be advantageous if a heating device is provided by means of which the washer fluid can be heated on at least a part of the way to at least one of the outlets. A heating wire or the like may in particular be routed to the outlet in order to prevent a freezing of the washer fluid even at temperatures below freezing point.

The features and feature combinations mentioned in the above description and the features and feature combinations described below in the description of the figures and/or shown in the figures only can be used not only in the specified combination, but also in other combinations or individually without exceeding the scope of the invention.

### BRIEF DESCRIPTION OF THE DRAWING FIGURES

Further advantages, features and details of the invention can be derived from the claims, the following description of preferred embodiments and the drawings, in which identical elements or elements of identical function are identified by the same reference numbers. Of the drawing:

FIG. 1 shows some components of a windscreen washer system for a motor vehicle, wherein distribution lines lead via a distributing device to washer fluid-carrying wiper blades of a windscreen wiper system of the motor vehicle;

FIG. 2 shows an alternative distributing device of a windscreen washer system according to FIG. 1; and

FIG. 3 is a section through a washer fluid-carrying wiper blade.

### DETAILED DESCRIPTION

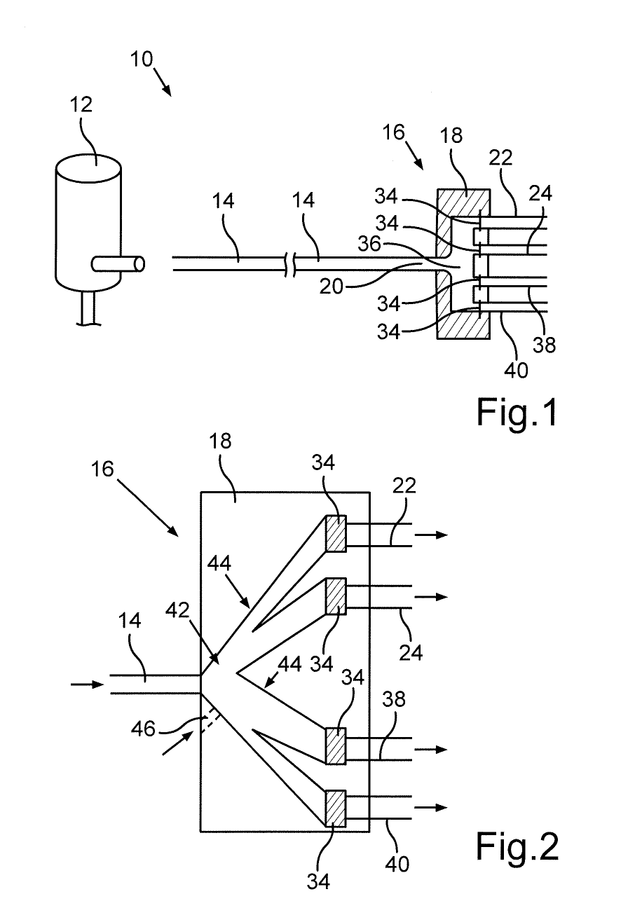

Of a windscreen washer system 10, FIG. 1 shows a pump 12 that delivers washer fluid from a reservoir (not shown). The pump 12 is connected to a supply line 14 via which the washer fluid is delivered to the windscreen of the motor vehicle which is to be wiped.

The supply line 14 terminates into a distributing device 16 that comprises a housing 18 with one inlet 20 and four outlets. The distributing device 16 is located in an engine compartment of the motor vehicle. The reason for this is that there is a comparatively large space available for the accommodation of the distributing device 16. In addition, the distributing device 16 is well protected and can easily be heated.

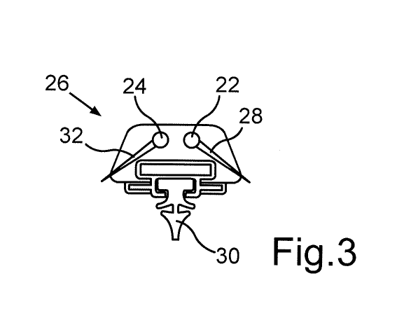

A first pair of distribution lines 22, 24 leads from two respective outlets of the distributing device 16 to a passenger-side wiper blade 26 (cf. FIG. 3). A corresponding passenger-side wiper blade 26 is constructed identically.

According to FIG. 3, a plurality of nozzles 28 is oriented from the first distribution line 22 routed through the wiper blade 26 in one wiping direction of the wiper blade 26. While the wiper blade 26 moves across the windscreen, washer fluid can be applied to the region of the windscreen that is immediately in front of a blade rubber 30 of the wiper blade 26 via these nozzles 28.

From the second distribution line 24, which is routed through the wiper blade 26 parallel to the first distribution line 22, washer fluid can be applied to a region of the windscreen that lies behind the blade rubber 30 in the wiping direction via nozzles 32 oriented against the wiping direction. While wiping with the wiper blade 26, the washer fluid is preferably applied to the windscreen through the nozzles 28, 32 in such a way that washer fluid is in each case applied to that region of the windscreen that lies in front of the blade rubber 30. Alternatively, both distribution lines 22, 24 could deliver washer fluid that can emerge via the respective nozzles 28, 32 simultaneously.

Solenoid-operated changeover valves 34 (cf. FIG. 1) are provided in the distributing device 16 for switching between the distribution lines 22, 24 and thus between the associated nozzles 28, 32. The independently switchable changeover valves 34 are located downstream of a branching chamber 36 within the housing 18 of the distributing device 16. Each of the changeover valves 34 allows the respective distribution line 22, 24 to be blocked or cleared.

Two further distribution lines 38, 40 extend from the distributing device 16 to the driver-side wiper blade 26, which is constructed analogously to the passenger-side wiper blade 26. Accordingly, by simultaneously opening the changeover valves 34 assigned to the distribution lines 22, 38, washer fluid can be applied simultaneously to the region of the windscreen that lies in front of the blade rubber 30 of the driver-side wiper blade 26 and the passenger-side wiper blade 26 in the wiping direction.

If stubborn dirt and/or insects have to be removed from the windscreen it is possible to apply washer fluid both to regions of the windscreen that are in front of the blade rubber 30 in the wiping direction and, via the distribution lines 24, 40, to the regions of the windscreen that are behind the blade rubber 30 in the same wiping direction.

The changeover from applying washer fluid to the windscreen via the distribution lines 22, 38 to applying the washer fluid via the distribution lines 24, 40 can be carried out as the wiper arm and the wiper blade 26 reach their reversing position or shortly before the reversing position is reached.

FIG. 2 is an enlarged detailed view of an alternative distributing device 16 with an inlet 16 to which the supply line 14 is connected and with four distribution lines 22, 24, 38, 40 leading to the wiper blades 26 (not shown in FIG. 2). As in the embodiment described above, the distributing device 16 of the embodiment of the windscreen wiper system shown in FIG. 2 is accommodated in the engine compartment of the motor vehicle.

Instead of the common branching chamber 36 shown in FIG. 1, however, the distributing device 16 according to FIG. 2 is provided with a first branching point 42 where the washer fluid is distributed between the passenger-side wiper blade 26 and the driver-side wiper blade 26. Downstream of this first branching point 42, there are two Y-junctions 44 where the passenger-side distribution lines 22, 24 and the driver-side distribution lines 38, 40 originate.

For blocking and clearing the distribution lines 22, 24, 38, 40, the four solenoid-operated changeover valves 34 are provided in the housing 18 of the distributing device 16. The changeover valves 34 are provided with integrated check valves. The housing 16 in which the changeover valves 34 are accommodated has a further connection 46 by way of which an insect removing agent and/or heated washer fluid can be introduced into the branching point 42.

In the arrangements of the distributing device 16 shown in FIGS. 1 and 2, the washer fluid can be discharged independently from the passenger-side distribution lines 22, 24 and the driver-side distribution lines 38, 40 owing to the independent control of the changeover valves 34 for the driver side and the passenger side. Larger quantities of washer fluid may be applied to either side, for example depending on local distribution of dirt on the windscreen.

The washer fluid is distributed between the distribution lines 22, 38 and 24, 40 respectively, which apply washer fluid to the windscreen in front of the blade rubber 30 as viewed in the wiping direction, in the distributing device 16.

The changeover valves 34 in the distributing device 16 allow the direction of the spray jet to be changed, depending on whether the washer fluid emerges from the wiper blade 26 via the nozzles 28 or via the nozzles 32 (cf. FIG. 3). If the emergence of washer fluid from the nozzle 28 is prevented by blocking the distribution line 22 before the wiper arm and the wiper blade 26 have reached their reversing position, and if at this point in time the washer fluid is already applied to the windscreen via the distribution line 24 and the nozzles 32, the washer fluid can act for a relatively long time, thereby softening any dirt.

The nozzles 28, 32 may enclose an acute angle with an (imaginary) central plane extending along the blade rubber 30 and perpendicular to the windscreen (cf. FIG. 3), such as an angle of 20° to 60°, in particular 30°. In addition, the nozzles can enclose an acute angle which is in particular open towards the axis of rotation of the wiper arm with the longitudinal axis of the wiper blade 26; this angle may be 5° to 30°, in particular 10° to 15°.

By means of the distributing devices 16 shown in FIGS. 1 and 2, it is further possible to block both driver-side distribution lines 38, 40 and to let washer fluid emerge via the passenger-side wiper blade 26 only. At the passenger-side wiper blade 26, too, washer fluid can be supplied independently both to the first distribution line 22 and to the second distribution line 24.

Washer fluid can therefore be supplied independently both to the driver-side and to the passenger-side wiper blade 26 and within the respective wiper blade 26 to the respective distribution lines 22, 24 and 38, 40 respectively.

The distribution lines 22, 24 and 38, 40 respectively are substantially oriented parallel to a longitudinal axis of the wiper blade 26. The distribution lines 22, 24 and 38, 40 respectively preferably extend along the entire length of the wiper blade 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. An arrangement of a windscreen wiper system with an associated windscreen washer system on a motor vehicle, comprising:
a washer fluid supply line;
a branch point connected to the washer fluid supply line;
at least two distribution lines connected downstream of the branch point, wherein the at least two distribution lines lead to respective outlets, wherein the outlets are configured to be moveable together with a corresponding wiper arm of the windscreen wiper system; and
a distributing device configured to control an emergence of washer fluid from at least one of the outlets, wherein the distributing device is located in an engine compartment or stowage space of the motor vehicle.

12. The arrangement according to claim 11, wherein at least one shut-off device, which is configured to block at least one of the at least two distribution lines, is arranged within a housing of the distributing device.

13. The arrangement according to claim 12, wherein the at least one shut-off device comprises at least two shut-off devices that configured to be independently controllable.

14. The arrangement according to claim 12, wherein the at least one shut-off device is a solenoid-operated switching element that includes a check valve.

15. The arrangement according to claim 12, wherein a first outlet of the outlets is at least substantially oriented in one wiping direction and a second outlet of the outlets is oriented in an opposite wiping direction.

16. The arrangement according to claim 15, wherein the first outlet or the second outlet is positioned on a wiper blade of the windscreen wiper system.

17. The arrangement according to claim 11, wherein the outlets are nozzles that are distributed over a length range.

18. The arrangement according to claim 11, wherein the distributing device has at least one connection configured to receive an additive that is a cleaning solution or a heated medium, which can be introduced into the washer fluid.

19. The arrangement according to claim 11, wherein the windscreen wiper system comprises at least two wiper arms, the at least two distribution lines being assigned to each of the wiper arms.

20. The arrangement according to claim 11, further comprising:
a heating device configured to heat the washer fluid at least part of the way to at least one of the outlets.
